(19) United States
(12) Patent Application Publication
(10) Pub. No.: US 2017/0158359 A1
(43) Pub. Date: Jun. 8, 2017

(54) ELECTROMAGNETIC THRUSTING SYSTEM

(71) Applicant: Cannae LLC, Doylestown, PA (US)

(72) Inventor: Guido Paul Fetta, Doylestown, PA (US)

(21) Appl. No.: 15/322,820

(22) PCT Filed: Jun. 30, 2015
(86) PCT No.: PCT/US15/38563

§ 371 Date: Dec. 29, 2016

Related U.S. Application Data
(60) Provisional application No. 61/998,502, filed on Jun. 30, 2014.

(51) Int. Cl. B64G 1/40; F03H 99/00

(52) U.S. Cl. CPC B64G 1/409; F03H 99/00

(57) ABSTRACT

Thrusting systems and vehicles are disclosed. One thrusting system includes a signal generator and a waveguide. The signal generator is configured to generate an electromagnetic wave. The waveguide is coupled to the signal generator to receive the electromagnetic wave such that at least a portion of electric and magnetic components of the electromagnetic wave extend in a direction transverse to a wave axis of the electromagnetic wave. The waveguide includes a dielectric material positioned to extend in a direction of the wave axis along a portion of the waveguide. An interaction between the electromagnetic wave and the waveguide induces a net force on the waveguide. One vehicle includes a thrusting system substantially as described above.

### FIELD OF THE INVENTION

The present invention is generally directed to thrusting systems and methods.

### BACKGROUND OF THE INVENTION

One issue facing space exploration programs is the development of an efficient, low-mass propulsion system. The necessity of including on-board propellant or reaction mass, as well as the mass on the engine itself, in traditional propulsion systems imposes practical limits to the range and lifetime of these propulsion systems. A number of approaches to this problem have been explored. Nonetheless, improved systems for generating thrust are desired.

### SUMMARY OF THE INVENTION

Aspects of the present invention are directed to thrusting systems and vehicles including thrusting systems.

In accordance with one aspect of the present invention, a thrusting system is disclosed. The thrusting system includes a signal generator and a waveguide. The signal generator is configured to generate an electromagnetic wave. The waveguide is coupled to the signal generator to receive the electromagnetic wave such that at least a portion of electric and magnetic components of the electromagnetic wave extend in a direction transverse to a wave axis of the electromagnetic wave. The waveguide includes a dielectric material positioned to extend in a direction of the wave axis along a portion of the waveguide. An interaction between the electromagnetic wave and the waveguide which includes the dielectric induces a net force on the waveguide.

In accordance with another aspect of the present invention, a vehicle is disclosed. The vehicle includes a thrusting system substantially as described above.

### BRIEF DESCRIPTION OF THE DRAWINGS

Aspects of the present invention are best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawing are the following figures:

FIG. 1 is a block diagram illustrating an exemplary thrusting system in accordance with aspects of the present invention;

FIG. 2 is a cross-sectional side-view, side-view, and end view diagram illustrating the exemplary thrusting system of the FIG. 1;

FIG. 3 is a cross-sectional diagram of an alternative exemplary thrusting system in accordance with aspects of the present invention;

FIG. 4 is a cross-sectional side-view, side-view, and end view diagram illustrating an alternative exemplary thrusting system in accordance with aspects of the present invention;

FIG. 5 is a circuit diagram of an exemplary signal generator in accordance with aspects of the present invention; and

FIG. 6 is a circuit diagram of an exemplary summary circuit of the signal generator of FIG. 5.

### DETAILED DESCRIPTION OF THE INVENTION

### General Overview

Embodiments of the present invention are capable of generating a net force on a body without requiring an on-board propellant. The net force generated by embodiments of the present invention may be used to propel objects such as vehicles, and/or may be used for other useful functions where such a net force is desirable.

In general, embodiments of the present invention comprise an electromagnetic waveguide which contains dielectric material and is connected to a signal generator. The signal generator is capable of sending electromagnetic (EM) waves into the waveguide. The EM waves may create a standing EM wave and/or a propagating EM wave in the waveguide. The standing EM wave and/or propagating EM wave interact(s) with the waveguide and the dielectric material to create a net force on the waveguide and on the dielectric material, as well as on any devices attached to the waveguide and the dielectric material. The net force is capable of accelerating the waveguide, the dielectric material, and any attached devices or vehicles.

The force generated by embodiments of the present invention may create linear and/or rotational accelerations on the dielectrically loaded waveguide. Linear accelerations are generated on embodiments where the force vector generated by interactions of the EM waves with the dielectrically loaded waveguide passes through the center of mass of the embodiment. Rotational accelerations are generated on embodiments where the force vector generated by interactions of the EM waves with the dielectrically loaded waveguide does not pass through the center of mass of the embodiment. The force generated by embodiments of the present invention may desirably be used to propel vehicles outside of the Earth's atmosphere.

### Definitions

The following paragraphs set forth definitions of the terms used in this application. These definitions apply to each use of the term in this description as well as the claims of this application

Signal Generator: Any device or combination of devices capable of creating an oscillating electromagnetic wave. The signal generator may or may not include a phase-lock-loop circuit. The signal generator may or may not include one or more voltage controlled oscillators. The signal generator may or may not include one or more amplifiers.

Control Unit: A system that is capable of controlling an aspect of the power and/or frequency and/or frequencies of the EM wave generated by the Signal Generator.

Waveguide: Any electrically conductive body capable of partially and/or fully containing electromagnetic energy. The transmission mode through the waveguide may be transverse magnetic (TM), transverse electric (TE), or transverse electromagnetic (TEM), or may be a hybrid mode which contains TM and/or TE and/or TEM modes. The waveguide may have openings on one end, openings on two ends or openings on more than two ends. The cross-sectional shape of the waveguide may be of any shape and may or may not be of uniform cross-sectional shape with respect to one, or more than one planes which intersect said waveguide. The waveguide may have a cross-sectional shape that varies along the wave axis of the contained EM wave energy.

Resonant Cavity: Any electrically conductive body capable of partially and/or fully containing electromagnetic energy. The electromagnetic energy mode within the resonant cavity may be TM, TE, TEM, or may be a hybrid mode which contains TM and/or TE and/or TEM modes. The resonant cavity may be open on one end, two ends or more than two ends. A resonant cavity is a specific form of a waveguide.

Coaxial Waveguide: A waveguide that is comprised of an outer conductor and an inner conductor within the outer conductor. The waveguide may or may not contain dielectric material between the inner and outer conductors.

Coax Transmission Line: A device comprised of a central conductor, and an outer conductor. The coax transmission line may or may not contain dielectric material between the inner and outer conductors. The coax transmission line may have a uniform cross-sectional shape or may have a non-uniform cross-sectional shape. The coax transmission line is capable of transmitting EM energy between the signal generator and the waveguide, or between either of these components and other components of embodiments of the present invention.

Termination: Any device capable of absorbing and/or recycling and/or reusing and/or reflecting the EM energy contained by a waveguide.

Dielectric Material: A material which is an electrical insulator that can be polarized by an applied electric field. Dielectric material can be solid, liquid, gaseous or plasma. Dielectric material may be used to refer to materials comprising one, two, or more different types of dielectric materials.

Dielectrically loaded waveguide: A waveguide that contains dielectric material. The dielectrically loaded waveguide may or may not contain sections comprising coaxial waveguides. The dielectric material within the dielectrically loaded waveguide may be of uniform or non-uniform configuration or structure. Multiple types of dielectric material may be used in the dielectrically loaded waveguide.

Standing Wave: A resonating wave mode which does not exhibit significant propagation during a work cycle of the wave. The standing wave is created by the reflection of a wave over itself, or by the interaction of two counter propagating, collinear waves of equal magnitude, frequency and polarization. Standing waves are characterized, in part, by electric and magnetic field nodes and anti-nodes of fixed position. The time-averaged Poynting vector of a standing wave is approximately zero.

Propagating Wave: An EM wave which transmits energy. Propagating waves are characterized, in part, by electric and magnetic field nodes and antinodes of non-fixed position. The time-averaged Poynting vector of a propagating wave is non-zero.

Standing TEM wave mode: An EM mode where greater than 50% and up to 100% of the EM energy (excluding EM energy lost to dissipation and/or in ohmic heating of the resonant structure and/or the dielectric structure) introduced into a waveguide and/or a resonant cavity oscillates with the electric field of the EM wave and the magnetic field of the EM wave 90 degrees temporally out of phase.

Propagating TEM wave mode: An EM mode where greater than 50% and up to 100% of the EM energy (excluding EM energy lost to dissipation and/or in ohmic heating of the resonant structure and/or the dielectric structure) of the EM energy introduced into a waveguide and/or a resonant cavity oscillates with the electric field of the EM wave and the magnetic field of the EM wave temporally in phase.

One Quarter Wavelength: For a standing wave, the shortest distance between an antinode and a node of the electric field and/or the magnetic field of an EM wave. For a propagating wave, one quarter of the distance between two proximal points of maximum electric field or magnetic field of an EM wave. The distance is calculated along the axis of the wave (i.e., in the direction of propagation of a propagating wave).

Wave Axis: In a standing wave, a surface (e.g., a line or plane) that includes all nodes or anti-nodes of the EM wave. For a propagating wave, a surface (e.g., a line or plane) extending in the direction of propagation of the EM wave.

On-board propellant: Any mass that is carried by a vehicle and expelled by the vehicle to generate thrust or otherwise propel the vehicle.

Phase-Lock-Loop: A device control system which is used to keep a signal generator tuned to a specific frequency which is characteristic of a resonator. The specific frequency of the resonator may change during normal operation of the resonator system, and the phase-lock-loop is configured to keep the frequency of the EM wave generated by the signal generator tuned to the time-varying specific frequency of the resonator, and tuned to keep the phase of the EM wave generated by the signal generator located at a predetermined location within the waveguide.

### Exemplary Embodiments

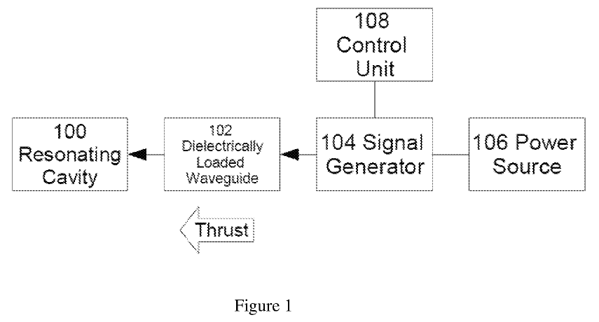

FIG. 1 illustrates an exemplary thrusting system in accordance with aspects of the present invention. The thrusting system includes a signal generator 104 and a waveguide 102. Waveguide 102 is a dielectrically loaded waveguide. Additional features of the thrusting system are set forth below.

Signal generator 104 is configured to generate an electromagnetic (EM) wave. Signal generator 104 is connected to waveguide 102 to transmit the EM wave to waveguide 102. Waveguide 102 is coupled to signal generator 104 such that waveguide 102 receives the EM wave with at least a portion of the respective electric and magnetic components of the EM wave extending a direction transverse to the wave axis of the EM wave within waveguide 102.

In exemplary embodiments of the present invention, signal generator 104 may comprise one or more synthetic EM signal generators, voltage controlled oscillators, digital waveform generators, or any EM signal generation techniques or apparatuses known to those skilled in the art to generate the EM signals used by the disclosed embodiments.

Embodiments of the present invention may operate using one, two, three or more multiple, distinct frequencies and/or phases within the waveguide. To this end, signal generator 104 may be configured to generate a plurality of electromagnetic waves having different frequencies and/or phases. The use of more than one frequency and/or phase within the waveguide may be used to create force vectors in more than one vector direction, may be used to create various force levels on the embodiment, or to serve other useful purposes. For example, use of one distinct frequency may create a net forward thrust direction on an embodiment, and use of a separate distinct frequency may create a reverse thrust on the same embodiment.

The frequency or frequencies of EM wave(s) generated by signal generator 104 may be selected based on a resonant frequency of waveguide 102, or may be generated based on one or more desired characteristics of force to be generated by the thrusting system. In an exemplary embodiment, an EM wave generated by signal generator 104 has a frequency from approximately 5 Hz to approximately 50 GHz. In a preferred embodiment, the EM wave has a frequency from approximately 1 MHz to approximately 5 GHz. In a more preferred embodiment, the EM wave has a frequency from approximately 900 MHz to approximately 950 MHz.

Embodiments of the present invention may utilize EM energy that propagates through the waveguide. Other embodiments of the present invention may utilize EM energy that resonates within the waveguide, e.g., in a standing wave Still other embodiments of the present invention may contain EM energy that partially propagates through and partially resonates within the waveguide 2. The amount of energy that propagates or stands within the waveguide may be selected based on the desired force generated by the thrusting system, and may be any amount from 1 to 100 percent of the total energy of the EM wave, excluding ohmic and/or dissipative losses. The propagation or lack thereof the EM energy may be controlled based on the shape, size, and materials of the waveguide, as will be understood by one of ordinary skill in the art from the description herein.

In some embodiments of the present invention, the EM wave resonates within the waveguide in a TEM mode (standing or propagating TEM mode) and/or in a hybrid mode which closely approximates a TEM mode. An EM wave mode that closely approximates a standing TEM mode is a wave mode in which the angle between the electric field oscillation plane and the magnetic field oscillation plane and the wave axis of the EM wave is greater than 45 degrees and less than 135 degrees, and more preferably, is between 85 degrees and 95 degrees. Said angle is 90 degrees for an ideal standing TEM wave.

Interactions of the EM wave with waveguide 102 cause a net force to be exerted on waveguide 102. This net force causes the acceleration of waveguide 102, signal generator 104, and any other components which are mechanically coupled to waveguide 102. Accordingly, embodiments of the present invention require no on-board propellant to create accelerations of the disclosed thrusting system.

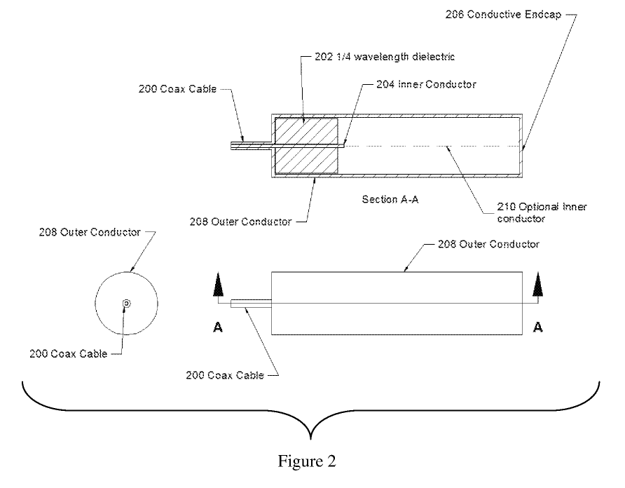

As shown in FIGS. 1 and 2, waveguide 102 may have first and second opposed ends. The ends may be open or may be closed or sealed. Exemplary embodiments of the ends of waveguide 102 are described below.

The first end of waveguide 102 is coupled to signal generator 104 to allow EM energy to be transmitted into waveguide 102 from signal generator 104. In one embodiment, the first end of waveguide 102 includes a coax transmission line to transmit EM energy from signal generator 104 to waveguide 102.

Embodiments of the present invention may be powered with one, two, or more than two signal ports for transmitting the EM wave into the waveguide. Embodiments may use signal ports that use the electric field of the EM wave to couple power into the waveguide, and/or may use signal ports that use the magnetic field of the EM wave to couple power into the dielectrically loaded waveguide, and/or may use both techniques to introduce EM power into the dielectrically loaded waveguide of the embodiment.

The second end of waveguide 102 may comprise a resonant cavity 100. Resonant cavity 100 may be integrally formed with waveguide 102, or may be a separate component that is coupled with waveguide 102, e.g., through a coax transmission line. In an embodiment, an opening in the second end of waveguide 102 allows EM energy to be transmitted out of waveguide 102 and into resonating cavity 100.

In the embodiment of FIG. 1, greater than 50% of the EM energy transmitted into waveguide 102 from signal generator 104 is transmitted into resonant cavity 100 after passing through waveguide 102. In this embodiment, the EM energy within waveguide 102 resonates in a standing TEM mode and/or in a mode that closely approximates a standing TEM mode at a specific frequency matching that of the resonant cavity. In an exemplary embodiment of the present invention, signal generator 104 operates by generating an EM wave having a frequency that is within a 20 dB bandwidth range to one or more resonant modes of waveguide 102 and/or resonant cavity 100.

Resonant cavity 100 may be added to control the frequency and/or amplitude of the resonant TEM wave oscillating within and/or propagating through waveguide 102. One or more resonant cavities 100 may be attached to waveguide 102 to serve other useful functions that will be apparent to those of ordinary skill in the art from the description herein.

In some embodiments, the second end of waveguide 102 comprises a termination. In one embodiment, the termination may be a reflective termination configured to reflect at least a portion of the EM wave which passes through waveguide 102. In another embodiment, the termination may absorb the transmitted EM energy which passes through waveguide 102. The absorptive termination on the second end of waveguide 102 may be configured to recycle the absorbed energy to signal generator 104, and/or may be configured to recycle the absorbed EM energy for other useful purposes such as generating heat, and/or may be configured to dissipate the absorbed EM energy.

In still other embodiments, the second end of waveguide 102 may be open and uncoupled to another structure. Such an opening allows the transmitted EM energy which passes through waveguide 102 to propagate away from waveguide 102.

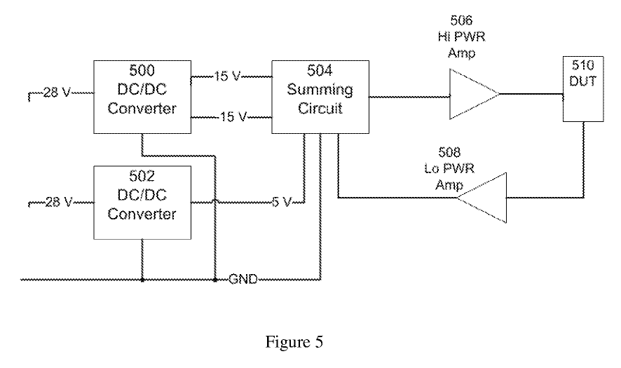

Embodiments of the present invention may include a phase-lock-loop electrically connected to the second end of waveguide 102. The phase-lock-loop is configured to control the frequency of the EM energy within waveguide 102. In particular, the phase-lock-loop circuit is coupled with signal generator 104 in order to adjust a frequency of the electromagnetic wave within waveguide 102 to compensate for changes in waveguide 102 over time (e.g., thermal changes). An example of a phase-lock-loop used by embodiments is depicted in FIG. 5. Other suitable circuits for creating a phase-lock-loop will be known to those of ordinary skill in the art from the description herein.

While embodiments of the present invention are described above as including coax transmission lines to transmit EM energy between signal generator 104, waveguide 102, and/or other components, it will be understood that the invention is not so limited. Any other suitable waveguides known to those of ordinary skill in the art from the description herein, including coaxial cables, may be used to transmit EM energy between the dielectrically loaded waveguides, signal generators, and other components of embodiments of the present invention.

The thrusting system may further include a power source 106. Power source 106 is connected with signal generator 104 and provides power to signal generator 104 for use by signal generator 104 in generating an electromagnetic wave.

The thrusting system may further include a control unit 108. Control unit 108 is coupled to signal generator 104, and controls one or more characteristics of the EM wave generated by signal generator 104. In an exemplary embodiment, control unit 108 modulates a frequency and/or power of the EM wave generated by signal generator 104. The EM wave with the modulated frequency and/or power is then transmitted to waveguide 102.

As set forth above, waveguide 102 is a dielectrically loaded waveguide. An exemplary embodiment of a dielectrically loaded waveguide is illustrated in FIG. 2.

As shown in FIG. 2, the waveguide includes dielectric material 202 positioned such that it extends in a direction of the wave axis along a portion of the waveguide. In an exemplary embodiment, the waveguide sustains EM energy within the waveguide in a standing wave of the lowest TEM mode and/or in a TEM mode which closely approximates a lowest-order standing TEM mode. Interactions of the EM energy with the waveguide and dielectric material 202 cause a net force to be exerted on said waveguide and dielectric material 202 which propels the waveguide and any devices attached to said waveguide.

Embodiments of dielectric material 202 may include more than one type of dielectric material. The different types of dielectric material may or may not have differing dielectric constants. Exemplary dielectric materials for use with the present invention include, for example, polytetrafluoroethylenes such as TEFLON®, polyethylene, polypropylene, styrene, polystyrene, carbon disulfide, asphalt, terpinine, amber, polymethyl methacrylates such as LUCITE° or PLEXIGLASS®, vulcanized rubber, acrylonitrile butadiene styrene (ABS), polycarbonate, biaxially-oriented polyethylene terephthalates such as MYLAR®, polyvinyl chloride, silicone rubber, polyimide, nylon, epoxy, sulfur, fused quartz, silicon dioxide, asbestos, polyvinyl chloride, bakelite, borosilicates such as PYREX® 7740, selenium, acetic acid, neoprene rubber, calcite, calcium carbonate, silicon carbide, cresol, silicon, lithium deuteride, germanium, lead oxide, ethylene glycol, lead sulfide (galena), titanium dioxide, barium titanate, strontium titanate, barium strontium titanate, potassium niobate, tin telluride, potassium tantalate niobate, lead magnesium niobate, hafnium silicate, hafnium dioxide, zirconium silicate, zirconium dioxide, calcium copper titanate, conjugated polymer dielectrics, or any suitable dielectric material known to those skilled in the art.

In some embodiments, the length of dielectric material 202 is less than an entire length of the waveguide. In embodiments of the present invention, the length of the portion of the waveguide covered by dielectric material 202 is selected based on a wavelength of the EM wave in the dielectric material. The wavelength of an EM wave within dielectric material 202 is proportional to 1/(k) times the free-space wavelength of the EM wave outside of the dielectric, where k is the dielectric constant of the material. The free-space wavelength will be determined by the frequency of the EM wave provided by the signal generator, and may further be selected based on a resonant mode of the waveguide. The dielectric constant k is the relative permittivity of the dielectric material. The determination of the wavelength of an EM wave in a dielectric material will be readily understood by one of ordinary skill in the art from the description herein.

In an exemplary embodiment, the length of dielectric material 202 is more than 1/100 and less than ½ of the wavelength of the electromagnetic wave in the dielectric material. In a preferred embodiment, the length of dielectric material 202 is approximately ¼ of the wavelength of the electromagnetic wave in the dielectric material. Dielectric material having a length equal to one quarter of the wavelength of a TEM wave within the waveguide may maximize the amount of net-force-generating interaction between the EM wave and the dielectric material, and thereby, maximize the net force created on the dielectrically loaded waveguide.

The use of bounds including 1/100 and ½ of the wavelength are not intended to be limiting of the thickness of a dielectric material section according to the invention. To the contrary, the lower and upper bounds of such thickness of dielectric material may be any thickness which produces a measurable net force on the thrusting system.

In addition to dielectric material 202, the waveguide may further include one opening, an inner conductor 204, an outer conductor 208, and a termination 206 opposite the opening. The opening of the waveguide of FIG. 2 is located where a coax cable 200 meets outer conductor 208. The configuration of the opening of the waveguide of FIG. 2 is for illustration purposes only. Any suitable waveguide opening configurations known to those of ordinary skill in the art can be used in embodiments of the present invention.

In an exemplary embodiment, termination 206 is a conductive end cap which encloses one end of the waveguide. The conductive end cap causes EM wave energy that is inserted into the waveguide to be reflected. This reflected EM energy causes a standing TEM wave to form within the waveguide. In embodiments of the present invention, inner conductor 204 may or may not be electrically connected to the conductive end cap, via an optional inner conductor 210, as shown in FIG. 2.

In an exemplary embodiment, the waveguide has a circular cross-section, as shown in FIG. 2. In this embodiment, outer conductor 208 is a cylindrical outer conductor, and inner conductor 204 extends along the wave axis coaxially with outer conductor 208. In other embodiments, the cross-sectional shape of the waveguide may be rectangular or any other configuration sufficient to sustain the EM energy within the waveguide.

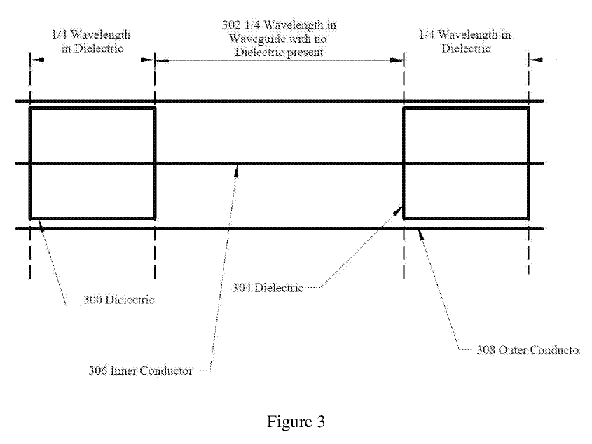

While FIG. 2 illustrates a waveguide including only a single portion of dielectric material, it will be understood that the invention is not so limited. FIG. 3 depicts a waveguide having two separate sections of dielectric material 300 and 304 within a section of a dielectrically loaded waveguide having an inner conductor 306 and an outer conductor 308. Dielectric material sections 300 and 304 extend in the direction of the wave axis along separate portions of the waveguide, between inner conductor 306 and outer conductor 308.

Where multiple dielectric material sections are used, the length of each individual section may be selected as discussed above with respect to the length of a single piece of dielectric material. Alternatively, a group of separate dielectric material sections may collectively have a length selected as discussed above. For example, a group of thin discs of dielectric material each having a thickness of 1/100 of the wavelength of the EM wave or less may be grouped (with or without small separating spaces) in a group having a collective length of approximately ¼ of the wavelength of the EM wave in the dielectric material.

As shown in FIG. 3, dielectric material sections 300 and 304 are separated by a space 302. Space 302 has a length along the direction of the wave axis that is approximately equal to ¼ of the wavelength of the EM wave in the space.

In an exemplary embodiment, the anti-node of the electric field of a resonating TEM wave within the waveguide is located at the left edge of dielectric material 300. However, the invention is not so limited, and the location of any nodes or anti-nodes of the TEM wave within the waveguide may be selected based on the net force to be produced by the thrusting system . The position of such nodes or anti-nodes may be controlled, for example, using the phase-lock-loop or based on the position of the antenna which transmits the EM wave into the waveguide relative to the waveguide.

Space 302 is not limited to having a length approximately equal to ¼ of the wavelength of the EM wave in the space. Where a space is used with one or more dielectric materials (such as the spaces in FIGS. 2 and 3), the space may have any desired length. For waveguides adapted to maintain resonant or standing waves, it may be desired that the space have a length that is a multiple of ¼ of the wavelength of the EM wave in the space, for example, ¼ wavelength, ½ wavelength, ¾ wavelength, etc.

Embodiments of the present invention are not limited to two sections of dielectric material. Any number of dielectric sections may be located within dielectrically loaded waveguides of embodiments of the invention, with adjacent sections each separated by spaces that are more than 1/100 and less than ½ of the wavelength (or multiples of this length) of the EM wave in the space. Preferably, the length of each space between adjacent dielectric material sections is approximately ¼ of the wavelength (or multiples of the ¼ wavelength) of the EM wave in the space.

Such dielectric material sections themselves are preferably positioned in regions of the EM wave field such that the interaction of the EM wave with the dielectric creates a net force vector which has a component that constructively adds to the net force generated by the embodiment. Additional sections of dielectric material may be added to embodiments of the present invention to create additional thrust on a dielectrically loaded waveguide.

Embodiments of the thrusting system described herein may also be used to propel a vehicle. Suitable vehicles including the disclosed thrusting system will be apparent to one of ordinary skill in the art from the description herein.

The thrusting system may be coupled to the vehicle to propel the vehicle in either a linear direction or a rotational direction. The thrusting system may provide linear thrust when the net force exerted by the thrusting system on the vehicle is aligned with a center of mass of the vehicle. The thrusting system may provide rotational thrust when the net force exerted by the thrusting system on the vehicle is along a line that does not pass through the center of mass of the vehicle. Alternatively, the thrusting system may provide rotational thrust by exerting a net force on the vehicle in rotational direction, i.e., through the use of a curved, U-shaped, or circular waveguide. Other arrangements for exerting a desired force on a vehicle will be known to those of ordinary skill in the art from the description herein.

In an exemplary embodiment, the vehicle may be a spacecraft, such as an orbital satellite. In this embodiment, it is desirable that the thrusting system produce sufficient force to maintain the orbital trajectory of the satellite. Accordingly, the thrusting system exerts a force on the vehicle having a magnitude greater than a force of atmospheric drag on the vehicle at the desired orbital altitude, e.g., from 50 to 1,200 miles above the surface of the Earth.

### Preferred Embodiments

The preferred embodiment of the present invention is depicted in FIGS. 1 and 4-6, and is comprised of a signal generator 104, a dielectrically loaded waveguide 102, a power source 106, a resonating cavity 100, and a control unit 108.

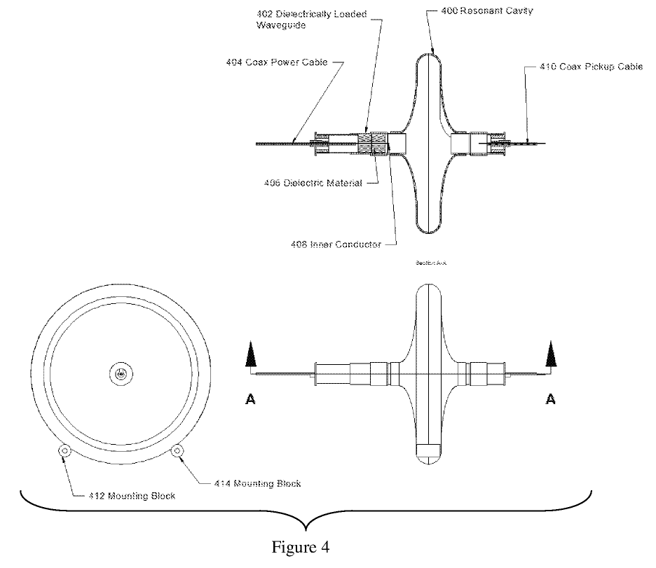

FIG. 4 depicts the dielectrically loaded waveguide 402 and the resonating cavity 400 of the preferred embodiment. The resonant cavity 400 is a copper structure with a 925 MHz TM₀₁₀ operating mode. The resonant cavity 400 is supported on mounting blocks 412 and 414.

The dielectric material 406 in the dielectrically loaded waveguide 402 of the preferred embodiment is a 1.75 in. long, 1 in. diameter TEFLON® polytetrafluoroethylene slug with a hole located at the axial center of the slug through which passes the inner conductor 408.

A coax power cable 404 is attached to the inner conductor 408, and is a semi-rigid coax cable. Inner conductor 408 of the dielectrically loaded waveguide 402 is created by stripping away the outer conductor and dielectric material surrounding the inner conductor of the semi-rigid coax cable 404.

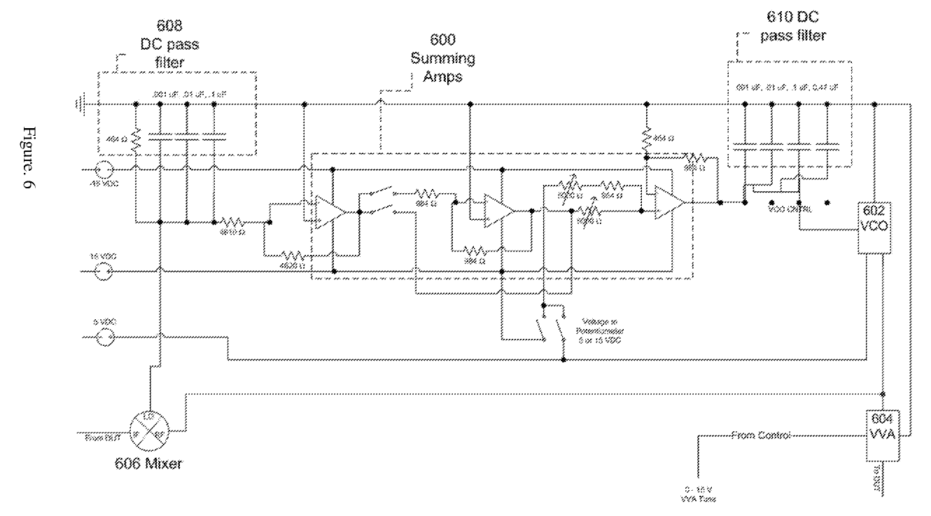

The coax power cable 404 transmits power to the inner conductor 408 which in turns transmits power into the dielectric material 406 and into the resonant cavity 400 of the preferred embodiment. A voltage controlled oscillator (VCO) 602 and a voltage variable attenuator (VVA) 604, illustrated in FIG. 6, are used to generate the RF signal that is transmitted through a high power RF amplifier 506 of FIG. 5 and then into the coax power cable 404 of FIG. 4.

The signal generation system of the preferred embodiment is controlled by a phase-lock-loop circuit which is depicted in FIGS. 5 and 6.

The phase-lock-loop operates by mixing a signal from the VCO 602 with a signal from a Device-Under-Test (DUT) 510, i.e., a signal that comes from the resonant cavity 400 via the coax pickup cable 410 of FIG. 4. The signal from DUT 510 is passed through a low power amplifier 508 and, together with the RF signal from the VCO 602, is sent into an RF mixer 606 to generate a DC offset signal. The offset signal from the mixer 606 is sent through a summing circuit 504. Summing circuit receives power from DC/DC converters 500 and 502. Summing circuit 504 is composed of summing amplifiers 600 which are connected with DC pass filters 608 and 610, as shown in FIG. 6. The summing circuit 504 combines the offset signal coming from the mixer 606 with an initial voltage used by the VCO 602 to control the frequency output of the VCO 602. By use of the phase-lock-loop control circuit, the VCO 602 always sends a signal with the correct frequency and phase (within tolerances) to the high power amplifier 506 and the resonant cavity 400 to maintain the resonant cavity 400 operating substantially in the TM₀₁₀ mode.

The phase-lock-loop is used by the preferred embodiment because the operational frequency of resonant cavity 400 and/or the operational frequency of the dielectrically loaded waveguide 402 may change during operation due to mechanical and/or thermal deformation of the resonant structures. The phase-lock-loop maintains the frequency generated by the signal generation circuits at or near the optimal operational frequency and phase of the embodiment.

Interactions of the EM wave within the dielectrically loaded waveguide 402 cause a time-averaged net force to be exerted on the dielectrically loaded waveguide 402. This net force creates thrust on the dielectrically loaded waveguide 402 and any bodies mechanically coupled to the dielectrically loaded waveguide 402.

The preferred embodiment of FIGS. 1 and 4-6 is a proof-of-concept prototype of the present invention. The preferred embodiment is capable of generating 40-50 pN of force when 30 watts of power is transmitted into the waveguide as the EM energy.

The following parts are used in the signal generation circuit of the preferred embodiment, and are illustrated in FIGS. 5 and 6:

| Component | Model | Supplier |
|---|---|---|
| VCO | ZX95-975-S+ | MiniCircuits |
| LO Amp | ZFL-1000+ | MiniCircuits |
| Power Dividers (2) | ZAPD-2-21-3W-S+ | MiniCircuits |
| 30 dB Dual Directional | 722-30.0-0.892 | Meca |
| Coupler | | |
| Power Meters (2) | ZX47-40LN-S+ | MiniCircuits |
| Amp | ZHL-30W-252-S+ | MiniCircuits |
| Mixer | ZP-5CH-S+ | MiniCircuits |
| Phase Shifter | PNR P1607 | ATM |
| VVA | ZX73-2500-S+ | MiniCircuits |
| Potentiometer (Summing | 5KOHMS - 3400S-1-502L | Bourns |
| Circuit) | | |
| Potentiometer (VVA) | 5KOHMS - 3400S-1-103L | Bourns |
| Op Amps (3) | NE5532 | Texas Instruments |
| DC to DC Converter | EC3AE | Cincon |

Although the invention is illustrated and described herein with reference to specific embodiments, it is not intended to be limited to the details shown. Rather, various modifications may be made in the details within the scope and range of equivalents of the claims and without departing from the invention. In particular, one skilled in the art may understand that many features of the various specifically illustrated embodiments may be mixed to form additional exemplary thruster systems and methods also embodied by the present invention.

What is claimed:

1. A thrusting system comprising:
a signal generator configured to generate an electromagnetic wave; and
a waveguide coupled to the signal generator to receive the electromagnetic wave such that at least a portion of electric and magnetic components of the electromagnetic wave extend in a direction transverse to a wave axis of the electromagnetic wave, the waveguide including a dielectric material positioned to extend in a direction of the wave axis along a portion of the waveguide,
wherein an interaction between the electromagnetic wave and the waveguide induces a net force on the waveguide.

2. The thrusting system according to claim 1, wherein a length of the portion of the waveguide along the wave axis is selected based on a wavelength of the electromagnetic wave in the dielectric material.

3. The thrusting system according to claim 2, wherein the length is more than 1/100 and less than ½ of the wavelength of the electromagnetic wave in the dielectric material.

4. The thrusting system according to claim 3, wherein the length is approximately ¼ of the wavelength of the electromagnetic wave in the dielectric material.

5. The thrusting system according to claim 1, wherein the waveguide comprises two or more separate sections of dielectric material extending in the direction of the wave axis along separate portions of the waveguide.

6. The thrusting system according to claim 5, further comprising a space between the two separate sections of dielectric material, the space having a length along the direction of the wave axis that is approximately equal to ¼ of the wavelength of the electromagnetic wave in the space.

7. The thrusting system according to claim 1, wherein a length of the portion of the waveguide is less than an entire length of the waveguide.

8. The thrusting system according to claim 1, wherein the waveguide has a circular cross-section.

9. The thrusting system according to claim 8, wherein the waveguide comprising an inner conductor extending along the wave axis, and an outer cylindrical conductor extending coaxially along the axis.

10. The thrusting system according to claim 1, wherein the waveguide includes first and second ends, the first end coupled to the signal generator.

11. The thrusting system according to claim 10, wherein the second end comprises a reflective termination configured to reflect at least a portion of the electromagnetic wave.

12. The thrusting system according to claim 10, wherein the second end comprises a resonant cavity.

13. The thrusting system according to claim 10, further comprising a phase-lock-loop circuit electrically connected to the second end of the waveguide, the phase-lock-loop circuit further coupled with the signal generator in order to adjust a frequency and phase of the electromagnetic wave within the waveguide to compensate for changes in the waveguide over time.

14. The thrusting system according to claim 1, wherein the waveguide is coupled to receive the electromagnetic wave such the electromagnetic wave in the waveguide exists in a transverse electromagnetic mode (TEM).

15. The thrusting system according to claim 1, wherein the electromagnetic wave is maintained as a standing wave within the waveguide.

16. The thrusting system according to claim 1, wherein the electromagnetic wave propagates through the waveguide.

17. The thrusting system according to claim 1, wherein the electromagnetic wave has a frequency from approximately 5 Hz to approximately 50 GHz.

18. The thrusting system according to claim 17, wherein the electromagnetic wave has a frequency from approximately 1 MHz to approximately 5 GHz.

19. The thrusting system according to claim 17, wherein the electromagnetic wave has a frequency from approximately 900 MHz to approximately 950 MHz.

20. The thrusting system according to claim 1, wherein the signal generator is configured to generate a plurality of electromagnetic waves having different frequencies and to selectively couple each of the electromagnetic waves to the waveguide.

21. The thrusting system according to claim 1, further comprising a power source connected with the signal generator, the power source providing power to the signal generator for generating the electromagnetic wave.

22. The thrusting system according to claim 1, further comprising a control unit coupled to the signal generator, the control unit configured to modulate a frequency and/or power of the electromagnetic wave generated by the signal generator.

23. A vehicle comprising the thrusting system of claim 1.

24. The vehicle according to claim 23, wherein the thrusting system is coupled to the vehicle to propel the vehicle in a substantially linear direction.

25. The vehicle according to claim 23, wherein the thrusting system is coupled to the vehicle to propel the vehicle in a rotational direction.

26. The vehicle according to claim 25, wherein the thrusting system exerts the net force along a line that does not pass through a center of mass of the vehicle.

27. The vehicle according to claim 25, wherein the thrusting system exerts the net force along the rotational direction.

28. The vehicle according to claim 23, wherein the net force exerted by the thrusting system on the vehicle has a magnitude greater than a force of atmospheric drag on the vehicle at an altitude from 50 to 1,200 miles above a surface of the Earth.
